(19) United States
(12) Patent Application Publication
(10) Pub. No.: US 2010/0318633 A1
(43) Pub. Date: Dec. 16, 2010

(54) Dynamic Time Weighted Network Identification and Fingerprinting for IP Based Networks Based on Collection

(75) Inventors: David Abzarian, Kirkland, WA (US); Todd L. Carpenter, Monroe, WA (US); Seshagiri Panchapagesan, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/485,773

(22) Filed: Jun. 16, 2009

(51) Int. Cl. G06F 15/16

(52) U.S. Cl. 709/219; 709/245; 709/224; 709/227; 709/238; 709/223; 706/12

(57) ABSTRACT

Techniques described herein describe a dynamic time weighted network identification and/or fingerprinting method. A method includes identifying one or more machines connected to a network of machines; performing an address resolution procedure on each of the one or more machines to determine one or more machine specific identifiers associated with each of the one or more machines; and applying a dynamic weighting to each identified machine on the network of machines as a function of a determined transience of each identified machine.

### BACKGROUND

The discussion below is merely provided for general background information and is not intended to be used as an aid in determining the scope of the claimed subject matter.

Public availability of Internet access continues to increase along with wireless networking and the proliferation of mobile computer users. Public Internet venues, such as Internet Cafés and the like typically subsidize the cost of providing Internet services through advertising revenues. Although advertising can assist in subsidizing publicly available Internet, problems with such subsidizing exist. For example, advertisers that pay for displayed advertising in public Internet locations have difficulty validating that public machines have actually displayed their advertising. Techniques for accounting or fiscal analysis for the advertising and other subsidized services on public machines, such as internet cafes, are limited. Current systems rely on operators of the Internet Café or other public location to report to the advertising source any details regarding use of the machines. Administrators at the public café's may be required to enter codes that identify the specific Internet Café and each public machine in the cafe in order to install proprietary software, making installing software on public machines problematic. Internet café's that change machines, including, for example, host computers, networking hardware, hubs, switches and routers and the like, create administrative difficulties when new software or machines must be installed.

### SUMMARY

Techniques described herein describe systems and methods for network identification and fingerprinting for Internet Protocol (IP) based networks. More specifically, systems and methods herein provide for self-identification of machines in a network to identify a working topology of any current machines on a network and assign a weighting to each current machine as a function of a transience determination. The self-identification and transience determination allow for each machine on a network to provide a current topology and transience determination to other host computers on a network and to a remote server. The current topology and transience determination enable a collector of data, either a remote collector or local administrator to determine an appropriate weighting scheme for the transience determination. Moreover, the topology and transience data enable logical network location correlation of data from multiple host computers across multiple networks.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE CONTENTS

The detailed description is described with reference to accompanying FIGs. In the FIGs, the left-most digit(s) of a reference number identifies the FIG. in which the reference number first appears. The use of the same reference numbers in different FIGs indicates similar or identical items.

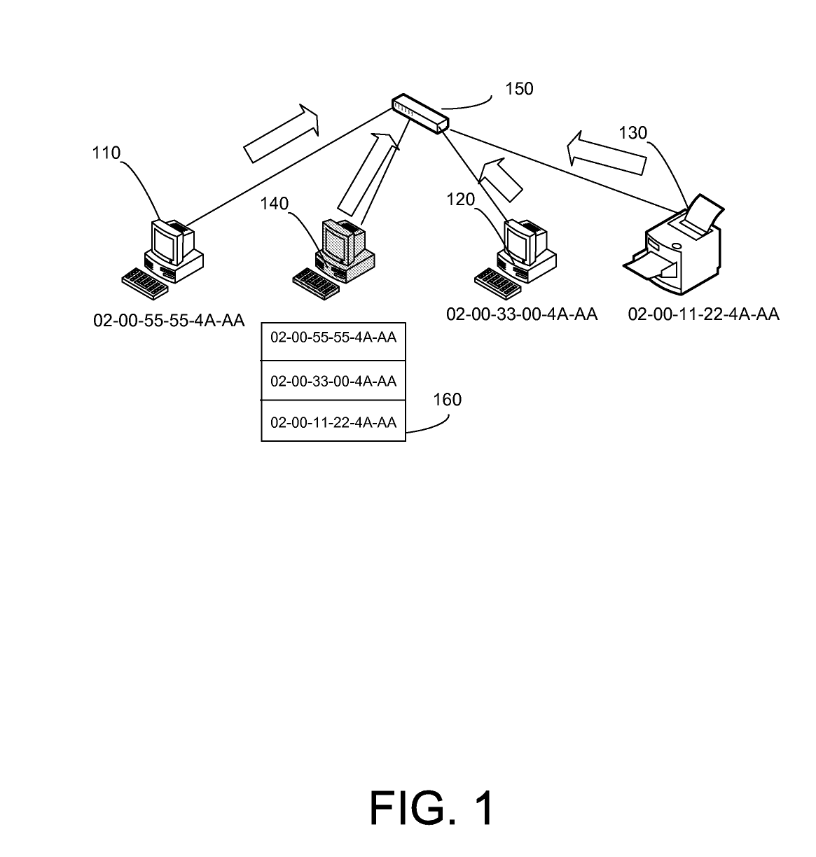

FIG. 1 shows an illustrative diagram of a dynamic time weighted network identification and fingerprinting system, including a default gateway machine coupled to other machines on a network, according to certain embodiments.

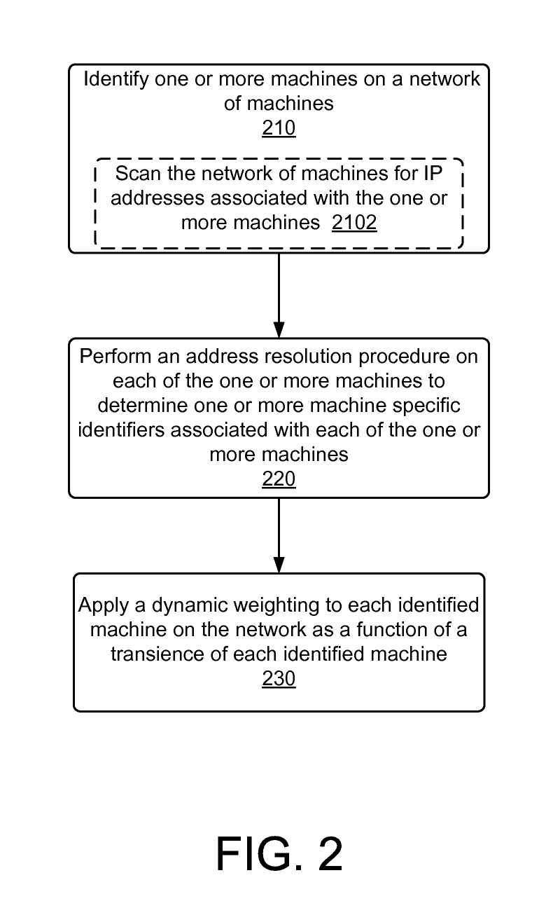

FIG. 2 shows an illustrative method for a dynamic time weighted network identification and fingerprinting system according to certain embodiments.

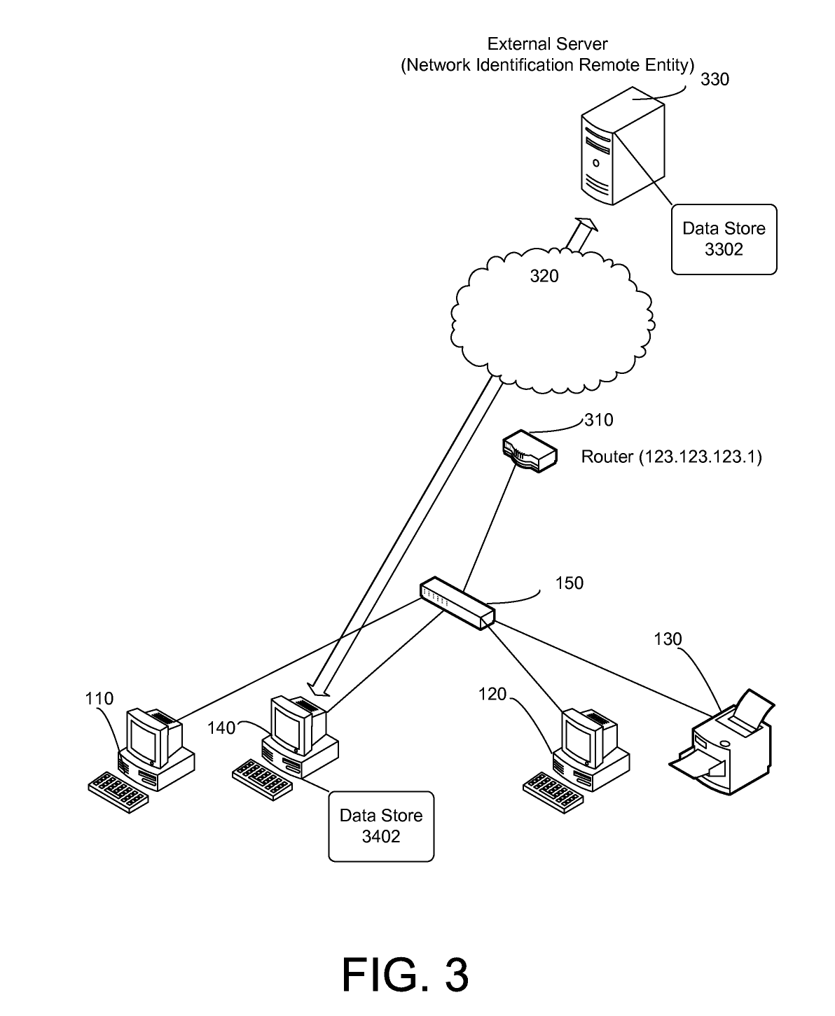

FIG. 3 shows an illustrative diagram of a dynamic time weighted network identification and fingerprinting system including a remote server according to certain embodiments.

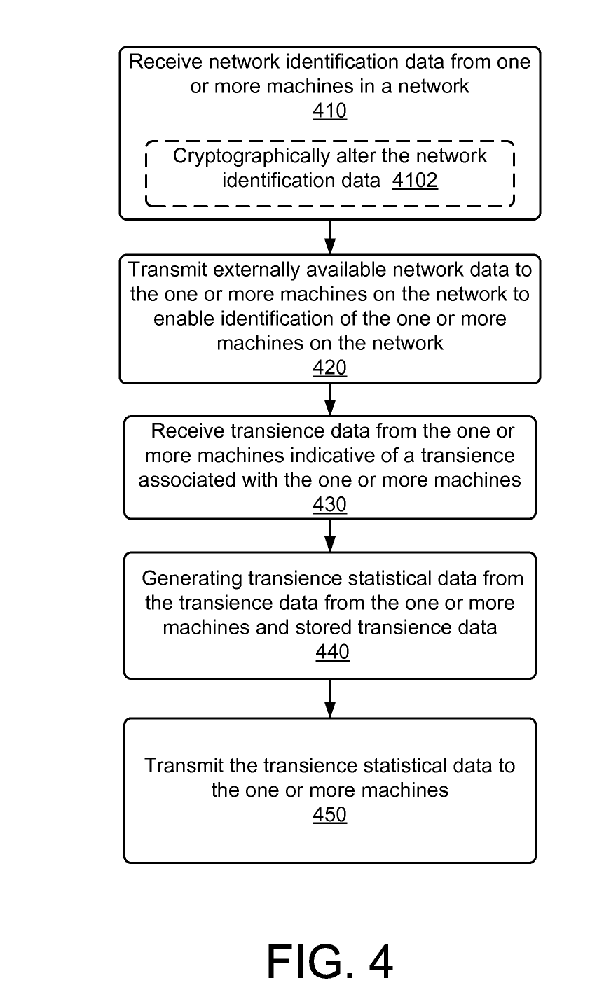

FIG. 4 shows an illustrative method for a dynamic time weighted network identification and fingerprinting system according to certain embodiments.

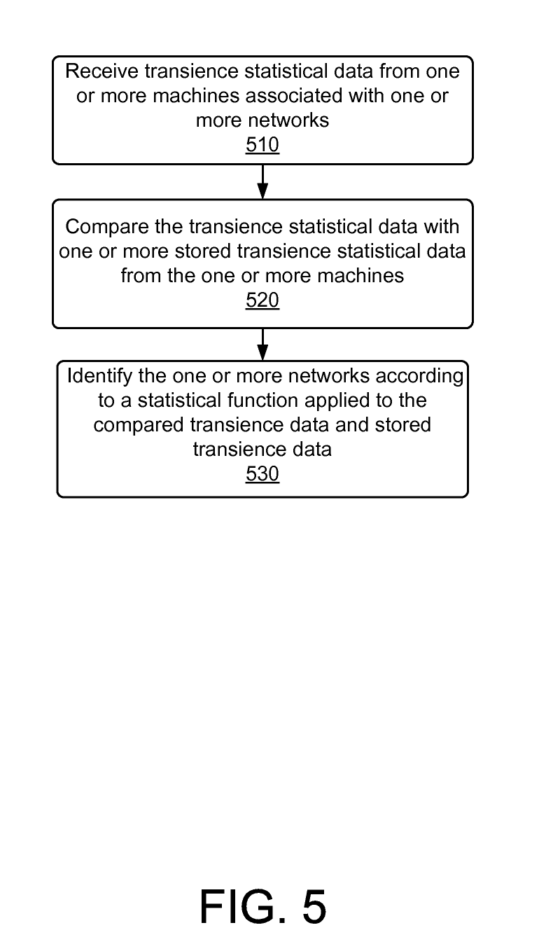

FIG. 5 shows an illustrative method for verifying an identity of a network using the dynamic time weighted network identification and fingerprinting system according to one or more embodiments.

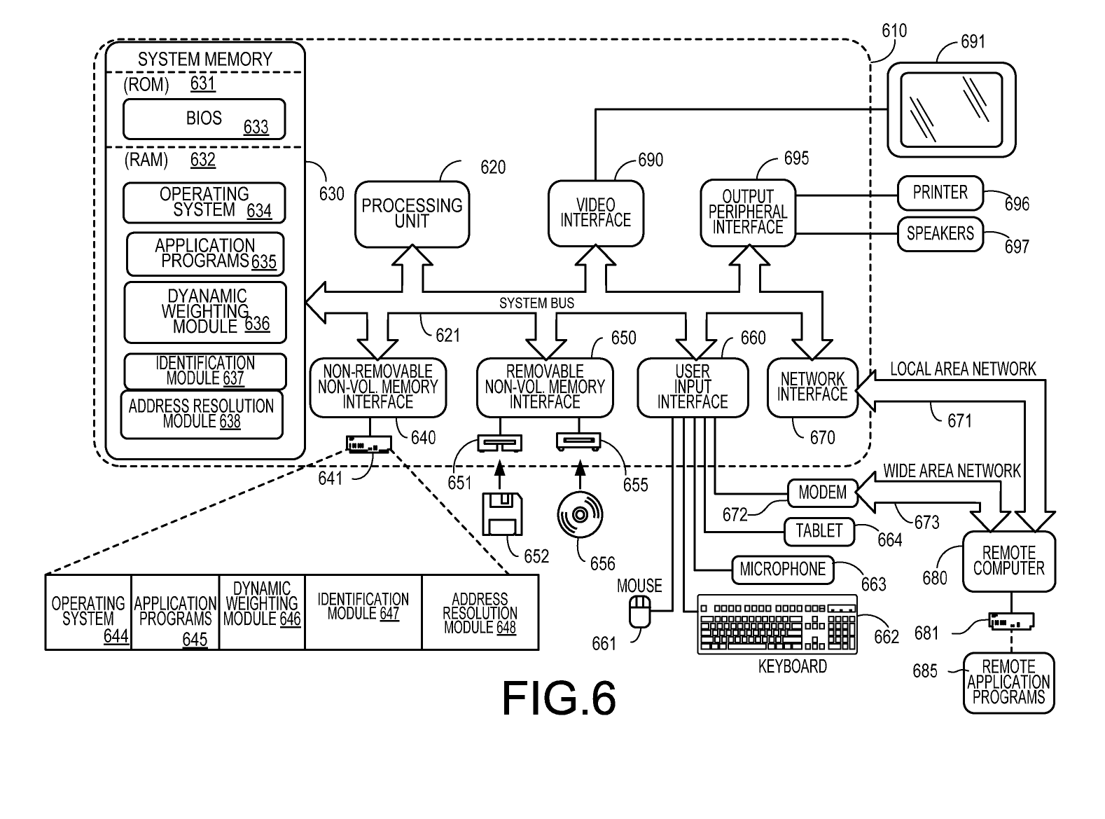

FIG. 6 illustrates one possible environment in which the systems and methods described herein may be employed, according to certain embodiments.

While the invention may be modified, specific embodiments are shown and explained by way of illustration in the drawings. The drawings and detailed description are not intended to limit the invention to the particular form disclosed, and instead the intent is to cover all modifications, equivalents, and alternatives falling within the spirit and scope of the present invention as defined by the claims.

### DETAILED DESCRIPTION

This document describes systems and methods for dynamic time weighted network identification and/or fingerprinting system. More specifically, embodiments herein provide a method for identifying remote computer usage.

### Illustrative Block Diagram

FIG. 1 is an illustrative block diagram illustrating various host components of a system for facilitating dynamic time weighted network identification and/or fingerprinting between a network gateway and the connected machines.

FIG. 1 illustrates that a plurality of machines (networked computers) 110, 120, 130 and 140. Machines can include networked computers 110, 120 and 140, a network printer 130, or other device with networking ability. Software running on each networked computer 110, 120 and 140 can perform scans to identify other machines in a local network, such as a public internet cafe. FIG. 1 further illustrates a switch or hub 150 that enables communication with each machine (networked computers) 110, 120, 130 and 140. Each machine 110, 120, 130 and 140 connected to the local network can have Internet connectivity through the switch, hub or router 150.

In an embodiment, one of the networked computers 110, 120 or 140 can operate with or without static routing functions. According to an embodiment, one or more networked computers identifies a subnet of machines via identified subnet internet protocol (IP) addresses. Once other machines are identified as being members of a current topology, the one or more networked computers can each perform a scan via an address resolution protocol (ARP) on the identified internet protocol (IP) address of each machine in the current topology to identify a media access control (MAC) address assigned to each machine. A MAC address is a unique 48-bit value assigned to the routing interface of each machine connected to a network. More specifically, referring to FIG. 1, machine 110 is illustrated with MAC address 02-00-55-55-4A-AA; machine 120 has MAC address 02-00-33-00-4A-AA, and machine 130 has MAC address 02-00-11-22-4A-AA. After machine 140 identifies a topology of current machines via subnet IP addresses, machine 140 determines the MAC addresses of each currently networked machine to create a list 160. In an embodiment, machine 140 sends the data collected to switch/hub/router 150. Switch/hub/router 150 can be configured as a router functioning as a default gateway that collects the data concerning each of the connected machines. As one of skill in the art with the benefit of the present disclosure will appreciate, any machine in a network capable of running host software can perform the methods described herein. Thus, each of machines, 110, 120 and 140 can perform scans to identify the topology of the local network and maintain a list such as list 160. Each list 160 can be sent to switch/hub/router 150 operating as a network gateway. Machines operating as host machines to collect data will also receive data, such as IP addresses from network equipment, such as switch/hub/router 150. In one embodiment host machines may share data between themselves, such as each of machines 110, 120 and 140 sharing data with each other machine. Also, each of machines 110, 120 and 140 may retrieve data from a remote entity. This information exchange may allow a new host machine to catch up with its peers in terms of what is less transient by incorporating the data sent to them. For example, if machine 110 is a new host machine on a network, other machines 120 and 140 could send data to machine 110 and enable machine 110 to have a weighting a more permanent machine.

Referring now to FIG. 2, a flow diagram illustrates a method according to an embodiment. This exemplary method may be described in the general context of computer executable instructions. Generally, computer executable instructions can include routines, programs, objects, components, data structures, procedures, modules, functions, and the like that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

As shown, block 210 provides for identifying one or more machines on a network of machines. For example, machine 140 can identify other machines on the network. A network could be a non-switched IP based network. In such a network, machines operating in promiscuous mode can detect traffic destined for other machines on a link in the network. Promiscuous mode refers to computers with a network interface card (NIC) set to “promiscuous mode” so that the machine receives all packets on a network link and not just packets addressed to the MAC Address for the machine.

For those networks operating in promiscuous mode, machines can use the packets detected on a network link to build a list of active IP addresses. Optional block 2102 disposed within block 210, provides for scanning the network of machines for IP addresses associated with the one or more machines. For example, machine 140 can scan for IP addresses on a subnet of IP addresses for a network, such as those IP addresses for machines 110, 120, 130 and switch/hub/router 150 to determine which machines are online at that time. In other networks, such as networks with changing IP addresses due to operations using a dynamic host configuration protocol (DHCP) or the like, IP addresses can be still be used to identify machines, but the IP addresses cannot be used to identify the machines on the network if they are not static. Rather, non-static IP addresses can be used to perform further operations to locate more permanent identifiers for the machines, such as MAC addresses.

In one embodiment, the identifying of the machines on a network includes querying an external source, such as a remote server. For example, an external source can identify an external IP address for a machine or a plurality of machines on a network. A machine on the network can query a remote server to provide information that is sent to that remote server to collect exposed external IP addresses.

An address resolution protocol (ARP) scan can enable identification of machines via enabling the querying machine to receive MAC addresses of other machines on a network. MAC addresses enable a more permanent identification of machines in a network than IP addresses because MAC addresses are generally permanent and in most cases associated directly with a specific piece of hardware.

Block 220 provides for performing an address resolution procedure, such as an ARP on each of the one or more machines to determine one or more machine specific identifiers associated with each of the one or more machines. For example, machine 140 can perform an ARP to determine a MAC address for one or more of identified machines such as machine 110 and 120.

On a switched IP network, the switch generally restricts traffic such that even a promiscuous host cannot see traffic that is not broadcast or not destined for a specific MAC address. A machine on a switched IP network can identify other machines by issuing an address resolution protocol (ARP) scan across the subnet range of the network. Similarly, if external IP addresses are collected from a remote entity and sent to a local machine, the local machine may request that the remote entity perform an ARP scan on its behalf. Therefore, the network can retrieve one or more MAC addresses by performing the ARP scan using those external IP addresses.

Block 230 provides for applying a dynamic weighting to each identified machine on the network as a function of a transience of each identified machine. For example, machine 140 can apply a weighting to each of machines 110, 120, and 130 according to a transience of each identified machine. For example, the transience can include a determination of whether machine 140 had previously identified machine 110, 120, and/or 130. To determine a transience, machine 140 can maintain a list of identified machines to perform a comparison with prior address resolution procedures, such as prior ARP scans.

In one embodiment, the transience is determined after a machine has first composed a list containing metadata related to previous scans. For example, after machine 140 compiles a list of active MAC addresses on the network, machine 140 can later apply a reverse address lookup using, for example, a Reverse Address Resolution Protocol (RARP) to determine machine IP addresses and compare to the prior list to determine if there was any change in the topology of machines.

In one embodiment, the weighting can include assigning those machines that are more transient with less weight than more permanent machines on a network. For example, if a machine has just been added to a network, a host computer such as machines 110, 120, and 130 performing a scan of machines on the network would determine that the machine's MAC address was not found in any previous scans of the network. Accordingly, a more transient weight would apply to such a machine. Conversely, if a particular machine is found each time a scan is performed, a more permanent machine is identified and weighted as being less transient. The weighting could be such that a lower weight is applied to machines that are more transient and a higher weight is given to machines that are less transient. For example, in some systems, the higher weighting could be granted network benefits as determined by a policy from an administrator or the like.

In another embodiment, the weighting can be in accordance with system requirements. For example, a weighting of each identified machine can be based on the number of entries, and each entry can be assigned a value. A default gateway, such as switch/hub/router 150 (or router 310) can be identified as a landmark in a network topology and have a MAC address that is given a substantially higher weighting than other machines on the network due to its non-transient nature. Additionally, weighting can be performed by each machine capable of scanning other machines in a local network. For example, referring back to FIG. 1, according to an embodiment, machines 110, 120, and 140 can each maintain its own list and metadata concerning the other machines in the network. Further, each machine can be configured to repeat a weighting calculation at a given interval.

In one embodiment, switch/hub/router 150 (or router 310 shown in FIG. 3) could be implemented with a network switch that includes one or more ARP caches. For example, a switch 150 configured to store ARP cache's could maintain an accessible ARP cache in accordance with the Simple Network Management Protocol (SNMP) and maintain a listing identifying MAC addresses and their associated physical ports, and the like. Such information could be provided to host computers on a network via a service. A separate host computer connected to that service could authenticate that the request comes from an authorized party. Additionally, in one embodiment, an ARP cache enabled switch 150 could provide data to a host computer that determines presence and timing information to enable real-time transience data for a connected network. As one of skill in the art with the benefit of the present disclosure will appreciate, data from a central switch, such as switch 150 would provide more accurate and real-time data than other machines connected to switch 150.

Weighting can also be calculated by a machine on a network each time a MAC address is active on a subsequent iteration of a network ARP scan. For example, if a subsequent scan performed by machine 140 indicates that machine 110 is connected to the network, the weight accorded to machine 110 can be increased because it has demonstrated more permanence. Thus, the weighting can by dynamic in that each machine on a network can alter an assigned weighting according to transience and other criteria.

Table 1, below illustrates an exemplary assignment of weights for FIG. 1 as seen by machine 140:

TABLE 1

| | | Percentage of | |
|---|---|---|---|
| | | detections within | |
| Machine | Current Status | predetermined period | Dynamic Weight |
| Machine 110 | Not online | 20% | 100 |
| Machine 120 | Online | 50% | 500 |
| Machine 130 | Online | 100% | 1000 |

As shown, a dynamic weighting can change in accordance with different variables and different weighting schemes. In Table 1, printer (machine) 130 could be a network printer that is always online and available. Accordingly, it is assigned a higher dynamic weight because it is more permanent. Conversely, machine 110 appears more transient and has a lower weighting.

The system could determine that weighting calculations should be performed regularly during a day or any appropriate predetermined period. Other methods of weighting dynamically can include performing detections of other machines sporadically, according to a random time period or other period appropriate for a given network.

The dynamic weight associated with the percentage of detections can be calculated on a linear basis so there is a direct correlation between detections and dynamic weight. In other embodiments, however, a dynamic weight can be determined as an exponential function, or other function depending on the network properties or other criteria. An exponential function could be more appropriate in circumstances under which fewer detections are necessary for determining a more permanent weighting.

In one embodiment, no single MAC address change causes a network to be identified differently from an earlier identification. Rather, a combination of changes can impact the identification. For example, depending on the function used to determine transience, a MAC address change combined with metadata such as a serial number change or manufacturer change of hardware in a network can be taken into account. Also, a MAC address change that recurs a predetermined number of times could cause a network to be identified differently. Thus, the weighting can be both dynamic and time adjusted.

Either a machine in a network or a remote web server can perform an inverse query or reverse lookup using one or more external IP addresses for the machines on the network. A protocol for performing a reverse lookup includes the InterNet Assigned Numbers Authority (IANA) protocol. IANA is responsible for allocation of IP addresses. An IANA reverse query using an external IP address can provide geographic location and ownership data on a given IP address including service provider and other details. This information can be collected by machines in a network to add information to a list of identifying information of other machines on a local network.

Referring now to FIG. 3, an embodiment is directed to including a remote server. Specifically, FIG. 3 includes machines 110, 120, 130 and 140 and includes router 310, internet 320 and remote server 330. Remote server 330 is shown including a data store 3302. In this embodiment, router 310 can operate as a network gateway, and collect data from each of machines 110, 120, 130, 140 and 150.

FIG. 3 illustrates how a remote server can assist a local machine in a network to identify other machines on a network. For example, after machine 140 passes data, such as data stored in data store 3402 to remote server 330, such as network identification data, remote server 330 can return any detected external IP addresses. These external IP addresses associated with the network enable machine 140, or other machines operating as a host, to perform an ARP to retrieve additional information about the machines in the network.

Referring now to FIG. 4, a flow diagram illustrates another method in accordance with an embodiment including a remote server, such as remote server 330.

Block 410 provides for receiving network identification data from one or more machines in a network. Disposed within block 410 is block 4102 which provides for cryptographically altering the network identification data. For example, in one embodiment, machine 140 collects network identification data, such as MAC address, IP addresses, serial numbers of machines on the network, and other metadata via a scan. Machine 140 can then organize the data into a network identification data listing. Machine 140 can also perform a hash of the data listing. A hash function or other randomizing function can enable machine 140 to send less data across the internet and also preserve privacy for the information sent. In one embodiment, multiple hashes of the data are computed using various portions of the data based on weighting and sent to the remote server 330. Those machines that share one or more of the same hashes can be considered part of the same network. The hashing function can apply to different components of the network identification data listing to enable further statistics to be determined by a remote server. Exemplary components can include the type of machine (computer, printer, mobile device), a manufacturer identifier, a serial number for a device, a MAC address, an IP address.

Block 420 provides for transmitting externally available network data to the one or more machines on the network to enable identification of the one or more machines on the network. For example, remote server 330 can transmit to machine 140 any externally detected IP addresses by performing an inverse query based on the received network identification data.

Block 430 provides for receiving transience data from the one or more machines indicative of a transience associated with the one or more machines. For example, after machine 140 determines MAC addresses of other machines operating within the network, data sent to remote server 330 can include a listing of all the machines detected by machine 140. The listing can include a hashed value of MAC addresses.

Block 440 provides for comparing the received data from the one or more machines to one or more stored transience data. For example, remote server 330 could receive the transience data from machine 140, which could only list a current view of machines on a network. Remote server 330 can include a data store 3302 that holds one or more prior received transience data. Remote server 330 can then compare prior received transience data to the received transience data to obtain a current transience of the one or more machines. The comparing can include determining which hash received from the one or more machines had more hits.

Block 450 provides for transmitting transience statistical data to the one or more machines. For example, if remote server 330 receives multiple hashes from a network, a statistical comparison can determine which hash had the most hits to allow a machine in the network, such as machine 140, to adjust its weighting scheme. The transience statistical data can increase the accuracy of transience data already in a machine regarding the prominence and permanence of other entities in the network.

Either an administrator of a network or an administrator of a remote server receiving transience data can calculate a dynamic weight. Exemplary criteria for dynamic weighting can include the following:
a number of times the one or more machines on a network connected to a switch/hub in the network;
an amount of time elapsed after a prior connection to the network for each of the one or more machines;
a lifetime determination for the one or more machines identifying how long each of the one or more machines existed on the network;
a comparison to other or previous weighting schemes applied across a network;
a determination of whether any of the machines of the one or more machines are entitled to preferential treatment; and
network outage or slowdown data concerning any of the one or more machines in the network.

In one embodiment, a weighting scheme can also be implemented using one or more of the above criteria automatically. For example, rather than an administrator determining weighting criteria, an artificial intelligence or self-learning weighting scheme can be implemented. Such an artificial intelligence weighting scheme can take place out of band (OOB) as such as an application running concurrently with network software but outside of in-band data streams.

In some embodiments, the weighting scheme can be configured to prioritize network data listings received by more permanent machines.

In another embodiment, the weighting can be overridden or supplemented by an aggregated policy coming from any combination of the administrator/operator and/or one or more remote entities. For example, an operator may choose to apply a higher weighting (or more permanence) to machines associated with specific MAC addresses. Alternatively or additionally, an administrator/operator could apply determine that machines associated with specific MAC addresses should be given a fixed weight. Also, a remote entity could specify that certain MAC addresses or machines associated with certain MAC addresses should not be used for weighting determinations or other policy calculations due to their generic nature. For example, machines with MAC addresses of “00-00-00-00-00-00” or similar informationally deficient addresses may be ignored. Also, in an embodiment, a remote entity or administrator/operator may determine for rescanning frequency and the like.

Referring to now FIG. 5, an embodiment is directed to a verification process that includes comparing a current network with a previously catalogued network. Either a host machine, such as machines, 110, 120 and 130 shown in FIG. 1 could have been previously identified and given a dynamic weighting.

According to an embodiment, verification of a network can include looking at the current data from a current scan and determining the current data and stored data match based on the weighting data.

The tables provided below illustrate the method for verifying a network. Each of Table 2, 3 and 4 represent previously collected data from three different networks received by, for example, a remote entity or local entity. Note that a host computer may not be simultaneously connected to three different networks, but could have information identifying three distinctly different networks over a period of time. For example, if a topology of computers changes over time, or if the host computer connects to a different network at a different location and stored that information.

TABLE 2
Network 1:

| Machine | Dynamic Weight |
|---|---|
| Machine 110 | 100 |
| Machine 120 | 500 |
| Machine 130 | 1000 |

TABLE 3
Network 2

| Machine | Dynamic Weight |
|---|---|
| Machine 210 | 1000 |
| Machine 220 | 5000 |
| Machine 230 | 100 |

TABLE 4
Network 3

| Machine | Dynamic Weight |
|---|---|
| Machine 310 | 50 |
| Machine 320 | 1000 |
| Machine 330 | 1000 |

Table 5 represents an exemplary detection of machines from a current scan. The current scanned data could include a determination of which machine is currently online:

TABLE 5

| | |
|---|---|
| Machine 110 | Online |
| Machine 230 | Online |
| Machine 220 | Online |

As shown in FIG. 5, according to a method, an entity would compare current data with stored data. Block 510 provides for receiving transience data from one or more machines associated with one or more networks. For example, as shown in Table 5, the transience data could include current data from a scan of a network. Block 520 provides for comparing the transience data to stored transience data related to two or more networks. For example, as shown in Tables 2, 3 and 4, an entity could have the dynamic weighting in the form of a catalog of tables. The entity wanting to determine a current network received as Table 5, could compare this to the catalog of known networks such as Tables 2, 3 and 4.

Block 530 provides for identifying the one or more networks according to a statistical function applied to the compared transience data and stored transience data. For example, a network could be identified according to a percentage of the weighting in the transience data, such as 80%. Comparing Table 5 to stored Tables 2, 3 and 4, for example, Table 5 is only a 6% match for Network 1 shown in Table 2, but an 82% match for Network 2, shown in Table 2. Therefore, a function requiring at least an 80% match would lead the verifying entity to believe that this is network 2. In one embodiment, the method performed in FIG. 5 can be accomplished in identification module shown in FIG. 6 below. In other embodiments, as would be appreciated by one of ordinary skill in the art with the benefit of this disclosure, the method of FIG. 5 can be performed in either a remote entity, such as a remote server, or a host machine in a network or other entity having an interest in network identification.

### Illustrative Computing Device

FIG. 6 illustrates an example of a suitable computing system environment on which the invention may be implemented. The computing system environment is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures as processor executable instructions, which can be written on any form of a computer readable medium.

With reference to FIG. 6, the suitable computing system environment includes a general purpose computing device in the form of a computer 610. Components of computer 610 may include, but are not limited to, a processing unit 620, a system memory 630, and a system bus 621 that couples various system components including the system memory 630 to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules and includes any tangible information delivery media or article of manufacture.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, a dynamic weighting module 536, and identification module 537 and address resolution module 538.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, dynamic weighting module 646, and identification module 647 and address resolution module 647. Note that these components can either be the same as or different from operating system 634, application programs 635, other dynamic weighting module 636, and identification module 637 and address resolution module 638. Operating system 644, application programs 645, dynamic weighting module 646, and identification module 647 and address resolution module 648 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user-input interface 660 or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as illustrative forms of implementing the claims.

What is claimed is:

1. One or more computer-readable media storing computer-executable instructions that, when executed on one or more processors, perform acts comprising:
identifying one or more machines connected to a network of machines;
performing an address resolution procedure on each of the one or more machines to determine one or more machine specific identifiers associated with each of the one or more machines; and
applying a dynamic weighting to each identified machine on the network of machines as a function of a determined transience of each identified machine.

2. The one or more computer-readable media as recited in claim 1, wherein the one or more computer-executable instructions configured for performing acts including identifying one or more machines connected to a network of machines further perform acts including:
scanning the network of machines for internet protocol (IP) addresses associated with the one or more machines.

3. The one or more computer-readable media as recited in claim 1, wherein the one or more computer-executable instructions configured for performing acts including identifying one or more machines connected to a network of machines further perform acts including:
remotely connecting to one of the one or more machines operating as a router or a switch for the network of machines.

4. The one or more computer-readable media as recited in claim 1, wherein the one or more computer-executable instructions configured for performing acts including identifying one or more machines connected to a network of machines further perform acts including:
transmitting a network data listing associated with the network of machines to a remote server.

5. The one or more computer-readable media as recited in claim 4, wherein the one or more computer-executable instructions configured for performing acts including transmitting a network data listing associated with the network of machines to a remote server further perform acts including:
receiving external internet protocol (IP) address data and the determined transience data from the external server to enable identification of the one or more machines.

6. The one or more computer-readable media as recited in claim 4, wherein the one or more computer-executable instructions configured for performing acts including transmitting a network data listing associated with the network of machines to a remote server further perform acts including:
receiving one or more external internet protocol (IP) addresses; and
performing an inverse query to identify one or more media access control (MAC) addresses associated with the one or more external IP addresses.

7. The one or more computer-readable media as recited in claim 1, wherein the one or more computer-executable instructions configured for identifying one or more machines connected to a network of machines further perform acts including:
compiling a network data list of active internet protocol (IP) addresses of the one or more machines on the network; and
sharing the network data list with each of the one or more machines and with a remote entity.

8. The one or more computer-readable media as recited in claim 1, wherein the one or more computer-executable instructions configured for performing an address resolution procedure on each of the one or more machines to determine one or more machine specific identifiers associated with each of the one or more machines further perform acts including:
collecting one or more medium access control (MAC) addresses of the one or more machines at one of the machines operating as a router for the one or more machines.

9. The one or more computer-readable media as recited in claim 1, wherein the one or more computer-executable instructions configured for performing an address resolution procedure on each of the one or more machines to determine one or more machine specific identifiers associated with each of the one or more machines further perform acts including:
collecting the one or more machine specific identifiers including one or more of machine manufacturer, machine serial number, machine owner identification, and machine internet provider data, and machine associated internet protocol (IP) data.

10. The one or more computer-readable media as recited in claim 1, wherein the one or more computer-executable instructions configured for applying a dynamic weighting to each identified machine on the network of machines as a function of a determined transience of each identified machine is further configured for:
performing a cryptographic function on one or more of the one or more machine specific identifiers.

11. The one or more computer-readable media as recited in claim 10, wherein the one or more computer-executable instructions configured for performing a cryptographic function on one or more of the one or more machine specific identifiers is further configured for:
performing a hash on one or more of a media access control (MAC) address, an IP address, a serial number or machine specific metadata.

12. A computer-readable medium having computer-executable components comprising:
an identification module configured to identify one or more machines connected to a network of machines;
an address resolution module coupled to the identification module, the address resolution module configured to determine one or more machine specific identifiers associated with each of the one or more machines on the network of machines; and
a dynamic weighting module coupled to the identification module, the identification module configured to assign a weight to each of the one or more machines as a function of a determined transience of each identified machine.

13. The computer-readable medium of claim 12 having computer-executable components further comprising:
a data store coupled the dynamic weighting module, the data store configured to store a prior determined weighting accorded the one or more machines connected to the network.

14. The computer-readable medium of claim 13 having computer-executable components wherein the identification module is further configured with one or more computer-executable instructions configured for
receiving transience data from the one or more machines associated with the network of machines;
comparing the transience data to stored transience data related to two or more networks of machines; and
identifying the network of machines according to a statistical function applied to the compared transience data and the stored transience data.

15. The computer-readable medium of claim 13 having computer-executable components wherein the data store is located in a remote server coupled to the network via an internet connection, the data store configured to store one or more hash values representing the one or more machine specific identifiers.

16. A method for determining machine-specific statistics associated with a network, the method comprising:
receiving network identification data from one or more machines in a network;
transmitting externally available network data to the one or more machines on the network to enable identification of the one or more machines;
receiving transience data from the one or more machines, the transience data indicative of a transience associated with the one or more machines; and
generating transience statistical data from the transience data from the one or more machines and stored transience data.

17. The method of claim 16 further comprising:
transmitting the transience statistical data to the one or more machines.

18. The method of claim 16 wherein the receiving network identification data from one or more machines in a network includes cryptographically altering the network identification data.

19. The method of claim 16 wherein the receiving network identification data from one or more machines in a network includes receiving metadata from the one or more machines, including at least a media access control (MAC) address for each of the one or more machines.

20. The method of claim 16 wherein the generating transience statistical data from the transience data from the one or more machines and stored transience data includes applying a dynamic weighting to the transience data, the dynamic weighting including one or more of a linear weighting according to a time value, an exponential weighting, an administrator determined weighting, or an automatic weighting according to a self-learning weighting scheme.
